(19) United States
(12) Patent Application Publication
(10) Pub. No.: US 2022/0123333 A1
(43) Pub. Date: Apr. 21, 2022

(54) FUEL CELL MODULE, POWER GENERATION SYSTEM, AND METHOD OF OPERATING FUEL CELL MODULE

(71) Applicant: Mitsubishi Power, Ltd., Kanagawa (JP)

(72) Inventors: Kimi KODO, Yokohama-shi, Kanagawa (JP); Hiroki IRIE, Yokohama-shi, Kanagawa (JP); Kazuo TOMIDA, Yokohama-shi, Kanagawa (JP); Yasutaka URASHITA, Tokyo (JP); Norihisa MATAKE, Tokyo (JP); Ryutaro MORI, Tokyo (JP)

(21) Appl. No.: 17/430,441

(22) PCT Filed: Dec. 17, 2019
(86) PCT No.: PCT/JP2019/049369

§ 371 Date: Aug. 12, 2021

(30) Foreign Application Priority Data
Feb. 25, 2019 (JP) 2019-032125

(51) Int. Cl. H01M 8/04111; H01M 8/2475

(52) U.S. Cl. CPC H01M 8/04111; H01M 8/2475

(57) ABSTRACT

A fuel cell module comprises: a plurality of single fuel cells each of which includes an anode, an electrolyte, and a cathode; a fuel gas supply pipe for supplying a fuel gas to the anode; an oxidant supply pipe for supplying an oxidized gas to the cathode of the plurality of single fuel cells, the oxidant supply pipe including a first line and a plurality of second lines each of which branches from a branch point at a downstream end of the first line and is connected to one or more single fuel cells; and at least one heating fuel gas supply pipe connected to the second line downstream of the branch point.

### TECHNICAL FIELD

The present disclosure relates to a fuel cell module, a power generation system including the fuel cell module, and a method of operating the fuel cell module.

### BACKGROUND

Fuel cells are known to generate power through chemical reaction between a fuel gas supplied to an anode and an oxidized gas supplied to a cathode, with a single fuel cell composed of the anode, electrolyte, and cathode as the smallest unit. Of these, a solid oxide fuel cell (SOFC) uses a solid oxide such as ceramic as the electrolyte, a gas such as city gas and natural gas as the fuel gas, and air containing oxygen as the oxidized gas, for example. Such a SOFC is known as a highly efficient high temperature fuel cell with a wide range of applications because of a high operating temperature of about 700 to 1000° C. to increase ionic conductivity. The SOFC can be combined with a rotating device such as a gas turbine, a micro gas turbine, or a turbocharger, for example, to increase the operating pressure for more efficient power generation. In this pressurized power generation system, compressed air discharged from a compressor is supplied to the cathode of the SOFC as the oxidized gas, and hot exhaust fuel gas discharged from the SOFC is supplied to a combustor at the inlet of the rotating device such as a gas turbine for combustion of the fuel gas. The hot combustion gas generated in the combustor is used to rotate the rotating device so as to recover the power.

Generally, the fuel cell is configured as a fuel cell module with a plurality of cartridges or cell stacks accommodating a plurality of single fuel cells.

The SOFC requires the single fuel cells to be heated to a high temperature during start-up. For heating the single fuel cells, Patent Documents 1 to 3 disclose the method in which the cathode is loaded with an oxidation catalyst to give a catalytic function, and when the cathode is at a temperature for catalytic combustion, the fuel gas with a concentration below the combustible limit is added to the oxidized gas for catalytic combustion to rise the temperature of the single fuel cells.

### CITATION LIST

### Patent Literature

### Patent Document 1: JP5601945B

### Patent Document 2: JP2018-6004A

Patent Document 3: U.S. Pat. No. 9,874,158B

### SUMMARY

### Problems to be Solved

In recent years, the number of cartridges or cell stacks in a module increases due to the trend toward higher capacities. Accordingly, there is a concern that the temperature variation between the cartridges or cell stacks increases. When the temperature varies, the amount of power generated by single fuel cells decreases. Thus, it is necessary to improve the temperature variation. In the method for heating single fuel cells disclosed in Patent Documents 1 to 3, the fuel gas is added from outside the fuel cell module to the upstream main pipe for supplying the oxidized gas to the fuel cell module. Therefore, the flow rate and concentration of the fuel gas cannot be adjusted for each of the cartridges disposed in the module. Therefore, the temperature cannot be adjusted for each cartridge.

An object of an embodiment of the present disclosure is to suppress the variation in temperature distribution of a plurality of single fuel cells accommodated in a module.

### Solution to the Problems

(1) A fuel cell module according to an embodiment comprises: a plurality of single fuel cells each of which includes an anode, an electrolyte, and a cathode; a fuel gas supply pipe for supplying a fuel gas to the anode; an oxidant supply pipe for supplying an oxidized gas to the cathode of the plurality of single fuel cells, the oxidant supply pipe including a first line and a plurality of second lines each of which branches from a branch point at a downstream end of the first line and is connected to one or more single fuel cells; and at least one heating fuel gas supply pipe connected to the second line downstream of the branch point.

Here, “downstream end” means the downstream end in the flow direction of the oxidized gas, and “downstream” means the downstream side in the flow direction of the oxidized gas. Further, the oxidized gas is a gas that contains about 15% to 30% oxygen, typically air is suitable, but other gases can also be used, such as a mixture of combustion flue gas and air, or a mixture of oxygen and air.

In the above configuration (1), the fuel gas is added from the heating fuel gas supply pipe to the second line during operation, and the fuel gas is introduced to the cathode of each single fuel cell disposed in the module to heat the single fuel cell by combustion of fuel gas. Since each of the second lines is connected to one or more single fuel cells, the heating fuel gas is supplied to the single fuel cells in a balanced manner. Thus, it is possible to suppress the variation in temperature distribution of the plurality of single fuel cells disposed in the module. As a result, it is possible to suppress the variation in power generation performance of the plurality of single fuel cells and improve the power generation performance.

(2) In an embodiment, in the above configuration (1), the fuel cell module comprises a fuel gas exhaust pipe for discharging an exhaust fuel gas from the single fuel cells. An upstream end of the heating fuel gas supply pipe is connected to the fuel gas exhaust pipe, and at least part of the exhaust fuel gas discharged to the fuel gas exhaust pipe is supplied to the single fuel cells through the heating fuel gas supply pipe and the second line.

With the above configuration (2), by supplying the non-combusted fuel gas discharged from the fuel gas exhaust pipe to the single fuel cells, the non-combusted fuel gas once discharged from the single fuel cells can be reused. Further, by supplying the diluted non-combusted fuel gas to the heating fuel gas supply pipe, the concentration of the fuel gas in multiple heating fuel gas supply pipes disposed in various positions can be adjusted.

(3) In an embodiment, in any one of the above configurations (1) to (2), the fuel cell module comprises one or more cartridges each of which accommodates two or more single fuel cells. Each of the second lines is connected to the one or more cartridges.

With the above configuration (3), since the oxidized gas can be supplied to the single fuel cells accommodated in one cartridge through one or few pipes constituting the second lines, the second lines can be simplified.

(4) In an embodiment, in the above configuration (3), a plurality of the cartridges are arranged in a row. The second lines include at least one fork pipe arranged along a row direction of the plurality of cartridges, and branch pipes branching from the at least one fork pipe and respectively connected to the plurality of cartridges. The at least one heating fuel gas supply pipe includes a heating fuel gas supply pipe connected to the one fork pipe that is disposed on a central portion in the row direction of the plurality of cartridges.

With the above configuration (4), since the heating fuel gas is supplied to the one fork pipe disposed on a central portion in the cartridge row direction, the heating fuel gas can be distributed to the downstream cartridges in a balanced manner.

(5) In an embodiment, in the above configuration (3) or (4), a plurality of the cartridges are arranged in a row. The second lines include at least one fork pipe arranged along a row direction of the plurality of cartridges, and branch pipes branching from the at least one fork pipe and respectively connected to the plurality of cartridges. The at least one heating fuel gas supply pipe includes a heating fuel gas supply pipe connected to the branch pipe connected to the cartridge that is disposed on at least one of both ends in the row direction of the plurality of cartridges.

When the oxidized gas is supplied from one or few second lines to the plurality of cartridges arranged in a row, the temperature of the cartridge at the end in the row direction tends to decrease. However, with the above configuration (5), the heating fuel gas can be supplied directly to the individual cartridge at the end in the row direction without any shortage.

(6) In an embodiment, in the above configuration (4) or (5), each of the second lines includes a straight pipe portion disposed on a side of a cartridge row, and the respective straight pipe portions of the second lines are disposed on opposite sides of the cartridge row with the cartridge row interposed therebetween.

With the above configuration (6), since the straight pipe portions of the second lines are disposed on opposite sides of the plurality of cartridges arranged in a row, the second lines can be made compact. When a common oxidized gas passage is formed for the single fuel cells accommodated in one cartridge, since the heating fuel gas can be supplied from both sides of each cartridge, the flow rate of the heating fuel gas supplied to the single fuel cells accommodated in each cartridge can be adjusted.

(7) In an embodiment, in any one of the above configurations (1) to (6), the fuel cell module comprises a valve disposed in the heating fuel gas supply pipe.

With the above configuration (7), since the flow rate of the fuel gas supplied from the heating fuel gas supply pipe to the second line can be controlled by the valve, it is possible to further suppress the variation in temperature distribution of the single fuel cells in the module.

(8) In an embodiment, in the above configuration (7), the fuel cell module comprises one or more temperature sensors for detecting a temperature of the single fuel cells.

With the above configuration (8), by adjusting the opening degree of the valve by the operator based on a detected value of the temperature sensor, it is possible to further suppress the variation in temperature distribution of the single fuel cells in the module. Further, the opening degree of the valve can be automatically adjusted based on a detected value of the temperature sensor.

(9) In an embodiment, in any one of the above configurations (1) to (8), the fuel cell module comprises a pressure vessel accommodating the plurality of single fuel cells. The heating fuel gas supply pipe penetrates the pressure vessel and includes an external pipe portion disposed outside the pressure vessel, and an internal pipe portion disposed inside the pressure vessel.

With the above configuration (9), since a part of the heating fuel gas supply pipe is disposed outside the pressure vessel, the pressure vessel can be downsized.

(10) In an embodiment, in the above configuration (9), the fuel cell module comprises a valve disposed in the heating fuel gas supply pipe, and the valve is disposed outside the pressure vessel.

With the above configuration (10), when the fuel cell module includes the pressure vessel, since the valve is disposed outside the pressure vessel, the operator can directly operate the valve.

(11) A power generation system according to an embodiment comprises: the fuel cell module having any one of the above configurations (1) to (10); and a rotating device configured to generate a rotational power by using an exhaust fuel gas and an exhaust oxidized gas discharged from the fuel cell module. The fuel cell module is supplied with the oxidized gas compressed by using the rotational power, and the fuel cell module generates power by using the fuel gas and the compressed oxidized gas.

With the above configuration (11), while achieving the object of the present disclosure, the power generation efficiency can be improved by supplying compressed oxidized gas to the fuel cell module, and the power required for the power generation system can be reduced with improved power generation efficiency by generating the rotational power using the exhaust fuel gas and the exhaust oxidized gas from the fuel cell module.

(12) In an embodiment, in the above configuration (11), the rotating device comprises a gas turbine or a turbocharger.

With the above configuration (12), in addition to improving the power generation efficiency and reducing the power required for the power generation system, since the rotating device is a gas turbine, combined power generation can be achieved with the fuel cell module and the gas turbine.

(13) A method of operating the fuel cell module according to an embodiment is a method of operating the fuel cell module having any one of the above configurations (1) to (10), comprising a heating step of heating the oxidized gas by adding the fuel gas from the at least one heating fuel gas supply pipe to the oxidized gas flowing through the second line.

With the above method (13), since each second line is connected to one or more single fuel cells, by performing the heating step, it is possible to suppress the variation in temperature distribution of the plurality of single fuel cells disposed in the module. As a result, it is possible to suppress the variation in power generation performance of the single fuel cells and improve the power generation performance.

(14) In an embodiment, in the above method (13), the heating step includes adding at least part of the fuel gas discharged from the single fuel cells to the oxidized gas flowing through the second line.

With the above method (14), the exhaust fuel gas discharged from the single fuel cells can be reused as the heating fuel gas, and by supplying the diluted exhaust fuel gas to the heating fuel gas supply pipe, the concentration of the fuel gas in multiple heating fuel gas supply pipes disposed in various positions can be adjusted.

(15) In an embodiment, in the above method (13) or (14), the heating step is performed when the fuel cell module is started at rated power generation or at partial load.

With the above method (15), since the heating step is performed when the fuel cell module is started at rated power generation or at partial load, it is possible to suppress the variation in temperature distribution of the plurality of single fuel cells in the module.

### Advantageous Effects

According to some embodiments, it is possible to suppress the variation in temperature distribution of the plurality of single fuel cells in the fuel cell module during operation. Thus, it is possible to suppress the variation in power generation performance of the plurality of single fuel cells and improve the power generation performance.

### BRIEF DESCRIPTION OF DRAWINGS

FIG. 1 is a schematic configuration diagram showing a schematic configuration of a fuel cell module according to an embodiment.

FIG. 2 is a perspective view of a fuel cell module according to an embodiment.

FIG. 3 is a schematic configuration diagram showing a schematic configuration of a fuel cell module according to an embodiment.

FIG. 4 is a perspective view of a fuel cell module according to an embodiment.

FIG. 5 is a transverse cross-sectional view of a fuel cell module according to an embodiment.

FIG. 6 is a longitudinal cross-sectional view of a cell stack according to an embodiment.

FIG. 7 is a schematic diagram of an oxidant supply pipe of a fuel cell module according to an embodiment.

FIG. 8 is a schematic diagram of an oxidant supply pipe of a fuel cell module according to an embodiment.

FIG. 9 is a schematic diagram of an oxidant supply pipe of a fuel cell module according to an embodiment.

FIG. 10 is a flowchart of a method of operating a fuel cell module according to an embodiment.

FIG. 11 is a flowchart of a method of operating a fuel cell module according to an embodiment.

FIG. 12 is a system diagram of a power generation system according to an embodiment.

FIG. 13 is a system diagram of a power generation system according to an embodiment.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

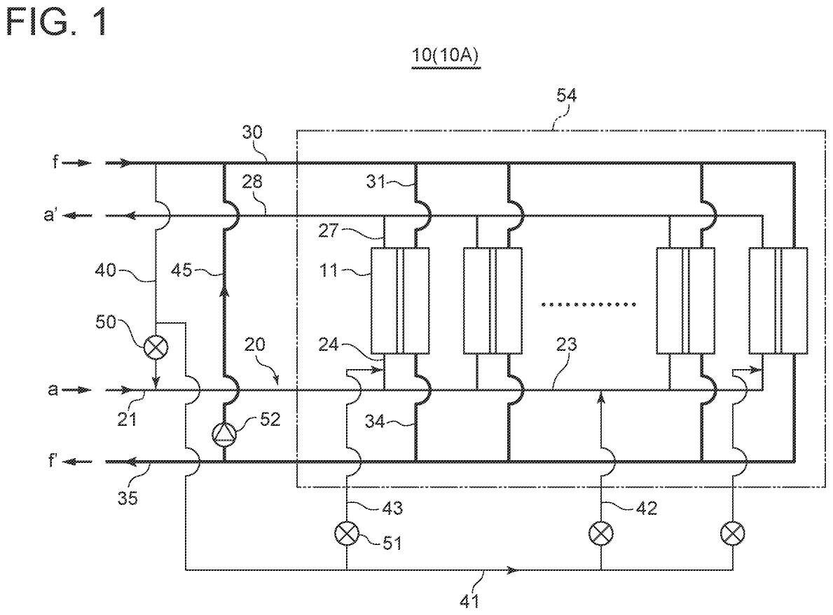

FIGS. 1 to 4 show a fuel cell module 10 (10A, 10B, 10C, 10D) according to some embodiments and components thereof. In FIGS. 1 to 4, the module 10 (10A, 10B) accommodates a plurality of single fuel cells each of which includes an anode, an electrolyte, and a cathode. If the power generation capacity of the module 10 is large, the number of single fuel cells is huge, and the huge number of single fuel cells are accommodated in one or more cartridges 11. Alternatively, a cell stack with a plurality of single fuel cells may be formed, and a plurality of cell stacks may be accommodated in one or more cartridges 11 each. Further, the fuel gas f is supplied from a fuel gas supply pipe 30 to the anode of each single fuel cell, and the oxidized gas a is supplied from an oxidized gas supply system 20 to the cathode. As a result, power is generated in the plurality of single fuel cells.

In the present embodiment, the oxidized gas supply system 20 includes an oxidant supply main pipe 21 (first line) disposed on the upstream side in the flow direction of the oxidized gas a, and a plurality of oxidant supply fork pipes 23 (23a, 23b) and oxidant supply branch pipes 24 (24a, 24b) (second lines) branching from a branch point 22 at the downstream end of the oxidant supply main pipe 21 and connected to each of the cartridges 11. Further, at least one heating fuel gas supply pipe 42 (42a, 42b) or 43 (43a, 43b) is connected to the oxidant supply fork pipe 23 or the oxidant supply branch pipe 24.

In the above configuration, during operation, for example when the module 10 is started, the fuel gas f is added from the heating fuel gas supply pipe 42 or 43 to the oxidant supply fork pipe 23 or the oxidant supply branch pipe 24. Since the added fuel gas f is combusted at the cathode of the single fuel cell to heat the single fuel cell, the start-up time can be shortened. As the method of combusting the fuel gas f, for example, an oxidation catalyst is loaded on the cathode, and when the oxidized gas reaches a temperature at which catalytic combustion is possible (e.g., 400° C. or higher), the fuel gas f is combusted by the catalytic action of the cathode. Since each of the oxidant supply fork pipes 23 or the oxidant supply branch pipes 24 is connected to one or more cartridges 11, the heating fuel gas f is supplied to the cartridges 11 in a balanced manner. As a result, it is possible to suppress the variation in temperature distribution of the plurality of cartridges 11 in the module 10. Thus, it is possible to suppress the variation in power generation performance of the plurality of single fuel cells and improve the power generation performance.

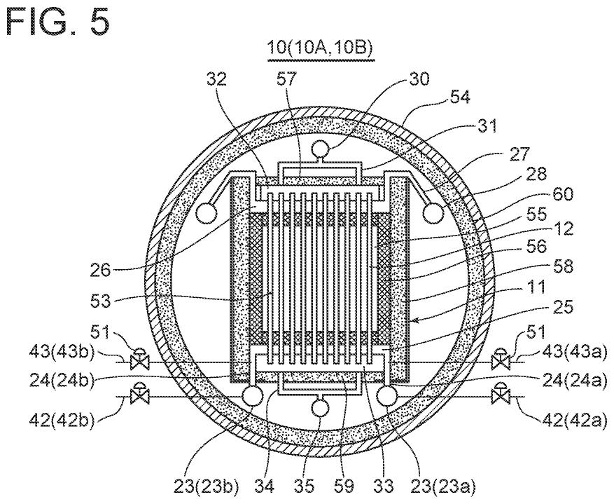

FIG. 5 is a transverse cross-sectional view of the module 10, where the cartridge 11 accommodates a plurality of cell stacks 12 to form a power generation chamber 55. Insulations 56, 57, 58, and 59 are disposed to surround the power generation chamber 55 formed by the plurality of cell stacks 12. The insulations insulate the power generation chamber 55 against the outside to prevent the heat generated in the power generation chamber 55 from escaping to the outside.

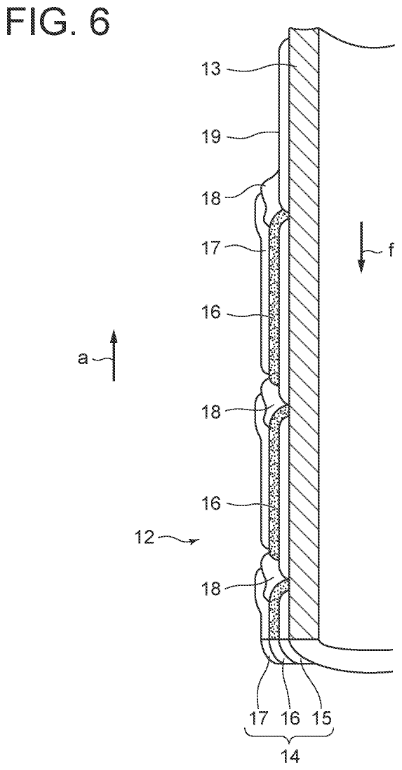

FIG. 6 is a longitudinal cross-sectional view of the cell stack 12 accommodated in the cartridge 11, where the cell stack 12 includes a plurality of single fuel cells 14. The single fuel cell 14 includes an anode 15, an electrolyte 16, and a cathode 17. In the cell stack 12, the plurality of single fuel cells 14 are formed on a substrate, and power is generated by the plurality of single fuel cells 14. In the following, a cylindrical cell stack 12 will be described as an example, but the cell stack may be a flat cylindrical or flat plate cell stack, for example.

As shown in FIG. 6, the cell stack 12 includes a cylindrical substrate tube 13, a plurality of single fuel cells 14 formed on the outer peripheral surface of the substrate tube 13, and an interconnector 18 formed between adjacent single fuel cells 14. The single fuel cell 14 is formed by laminating the anode 15, the electrolyte 16, and the cathode 17. Further, the cell stack includes a lead film 19 electrically connected to the cathode 17 of the single fuel cell 14 formed at one end in the axial direction of the substrate tube 13, and a lead film (not shown) electrically connected to the anode 15 of the single fuel cell 14 formed at the other end in the axial direction of the substrate tube 13 among the plurality of single fuel cells 14.

The interconnector 18 is electrically conductive and electrically connects adjacent single fuel cells 14, specifically, the cathode 17 of one single fuel cell 14 and the anode 15 of the other single fuel cell 14 to connect the adjacent single fuel cells in series. The lead film 19 is electrically conductive and conducts the DC power generated by the plurality of single fuel cells 14 connected in series by the interconnector 18 to near the end of the cell stack 12.

In an embodiment, as shown in FIG. 5, the fuel gas supply pipe 30 is provided above the plurality of cartridges 11 and is connected to each cartridge 11 via a plurality of fuel gas supply branch pipes 31. The fuel gas f is supplied in each cartridge 11 from the fuel gas supply pipe 30 to a fuel gas supply header 32 disposed inside the insulation 57. The fuel gas f supplied to the fuel gas supply header 32 passes through the substrate tube 13 constituting the cell stack 12 and is used to generate power in the single fuel cells 14. The exhaust fuel gas f′ after being used for power generation flows into a fuel gas exhaust header 33 formed below the power generation chamber 55, and is discharged from the fuel gas exhaust header 33 to the outside of the module 10 through a fuel gas exhaust branch pipe 34 and a fuel gas exhaust pipe 35.

In an embodiment, an oxidant supply header 25 is disposed inside the cartridge 11 and below the power generation chamber 55. The oxidized gas a is supplied to the oxidant supply header 25 through the oxidant supply fork pipes 23 (23a, 23b) and the oxidant supply branch pipes 24 (24a, 24b). The oxidized gas a supplied to the oxidant supply header 25 flows into the power generation chamber 55 through a gap (not shown) formed between the cell stack 12 and the insulation 56, and is used to generate power in the single fuel cells 14. The exhaust oxidized gas a′ after being used for power generation flows into an oxidant exhaust header 26 formed above the power generation chamber 55 through the gap, and is further discharged from the oxidant exhaust header 26 to an oxidant exhaust pipe 28 through an oxidant exhaust branch pipe 27.

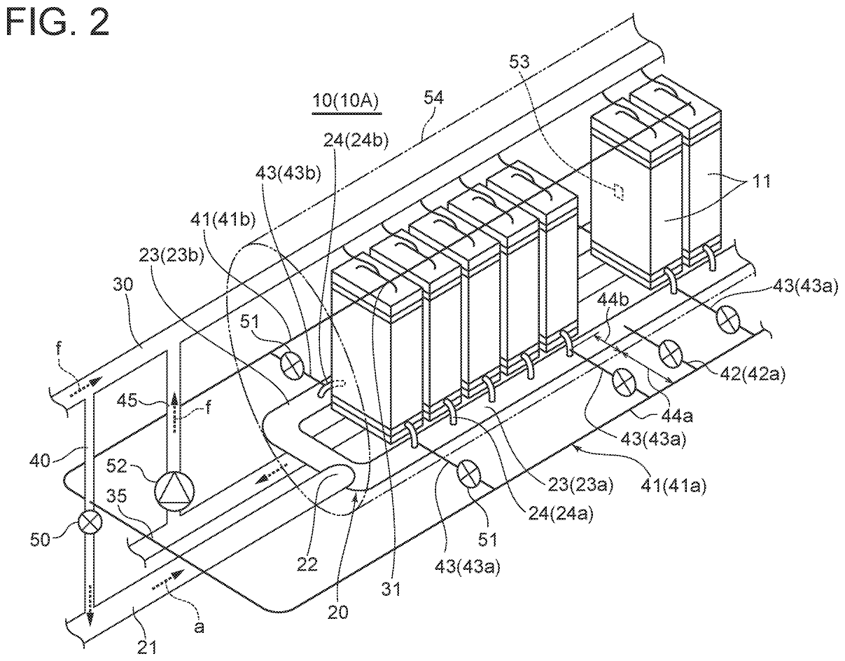

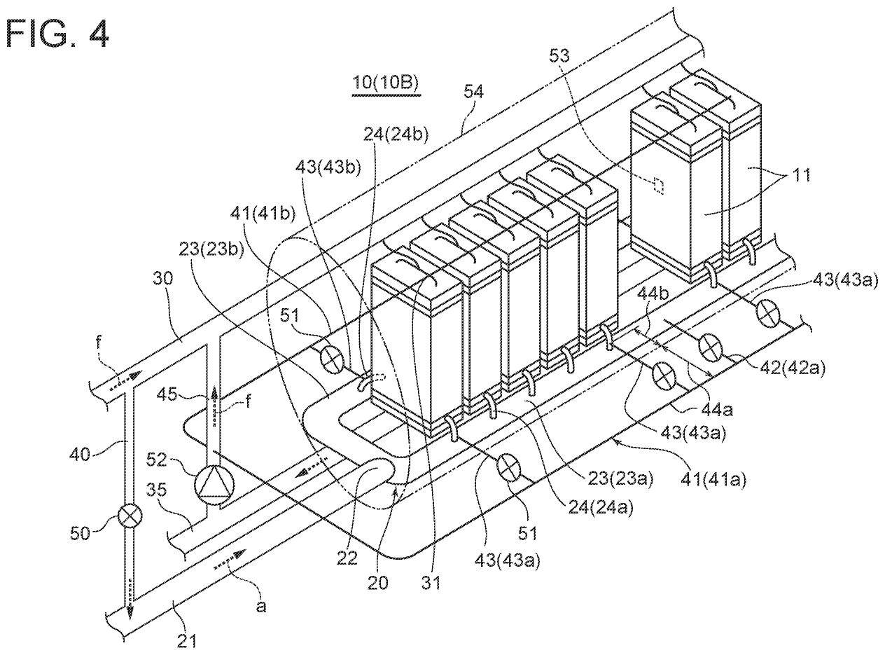

In FIGS. 2 and 4, the exhaust system for the exhaust oxidized gas a′ is not illustrated.

In an embodiment, as shown in FIGS. 1 to 4, a connection pipe 40 is connected between the fuel gas supply pipe 30 and the oxidant supply main pipe 21. The connection pipe 40 is provided with a valve 50. Part of the fuel gas f flowing through the fuel gas supply pipe 30 is supplied to the cartridges 11 via the oxidant supply main pipe 21, the oxidant supply fork pipe 23, and the oxidant supply branch pipe 24 as the heating fuel gas f when desired. However, when this supply system is used to supply the heating fuel gas to the cartridges 11, the flow rate and concentration of the fuel gas f supplied to each cartridge 11 cannot be adjusted. Therefore, the temperature cannot be adjusted for each cartridge 11.

For this reason, in the embodiments shown in FIGS. 1 and 2, a heating fuel gas supply main pipe 41 is provided to connect the connection pipe 40 and the heating fuel gas supply pipe 42 (42a, 42b) or 43 (43a, 43b) so that the heating fuel gas f is supplied from the connection pipe 40 to the heating fuel gas supply pipe 42 or 43 via the heating fuel gas supply main pipe 41. As a result, the heating fuel gas can be supplied to the plurality of cartridges 11 in a balanced manner, so that it is possible to suppress the variation in temperature distribution of the plurality of cartridges 11.

In an embodiment, as shown in FIGS. 1 to 4, the module includes one or more cartridges 11. Each cartridge 11 accommodates a plurality of single fuel cells 14. For example, as shown in FIGS. 5 and 6, the plurality of single fuel cells 14 are accommodated as the cell stack 12. The oxidant supply fork pipe 23 is connected to the one or more cartridges 11 via the oxidant supply branch pipes 24. Thus, since the oxidized gas a can be supplied to the single fuel cells 14 accommodated in one cartridge 11 through one or few pipes constituting the oxidant supply fork pipes 23 and the oxidant supply branch pipes 24, the number of oxidant supply fork pipes 23 and oxidant supply branch pipes 24 can be reduced, so that the pipes can be simplified.

In an embodiment, as shown in FIGS. 1 and 2, the heating fuel gas supply pipe 42 or 43 is provided with a valve 51. Since the flow rate of the fuel gas f supplied from the heating fuel gas supply pipes 42 and 43 to the oxidant supply fork pipe 23 and the oxidant supply branch pipe 24 can be adjusted by the valve 51, it is possible to further suppress the variation in temperature distribution of the single fuel cells 14 in the module 10.

The valve 51 may be an open/close valve capable of only opening and closing operations, or may be a flow-rate adjustment valve capable of adjusting the flow rate.

In an embodiment, as shown in FIGS. 2 and 4, the module includes a temperature sensor 53 for detecting the temperature of the single fuel cells 14. According to this embodiment, by operating the opening and closing of the valve 51 by the operator based on a detected value of the temperature sensor 53, it is possible to further suppress the variation in temperature distribution of the single fuel cells 14 in the module 10.

In this embodiment, a plurality of temperature sensors 53 may be provided for each cartridge 11. Further, the opening degree of the valve 51 may be automatically adjusted based on a detected value of the temperature sensor 53.

In an embodiment, as shown in FIGS. 1 to 4, a pressure vessel 54 is provided, and the plurality of single fuel cells 14 are accommodated in the pressure vessel 54. On the other hand, the valve 51 is disposed outside the pressure vessel 54. According to this embodiment, since the valve 51 is disposed outside the pressure vessel 54, the operator can directly operate the valve 51. Further, since the single fuel cells 14 are accommodated in the pressure vessel 54, it is safe to supply pressurized fuel gas f and oxidized gas a to the single fuel cells 14. By supplying the pressurized fuel gas f and oxidized gas a, the power generation performance of the module 10 can be improved.

In the embodiment shown in FIG. 5, an insulation 60 is disposed on the inner surface of the pressure vessel 54. This prevents the heat in the pressure vessel 54 from escaping outside the pressure vessel 54.

In an embodiment, as shown in FIGS. 1 to 5, the heating fuel gas supply pipes 42 and 43 penetrate the pressure vessel 54 and include an external pipe portion 44a disposed outside the pressure vessel 54 and an internal pipe portion 44b disposed inside the pressure vessel 54. According to this embodiment, since parts of the heating fuel gas supply pipes 42 and 43 are disposed outside the pressure vessel 54, the pressure vessel 54 can be downsized.

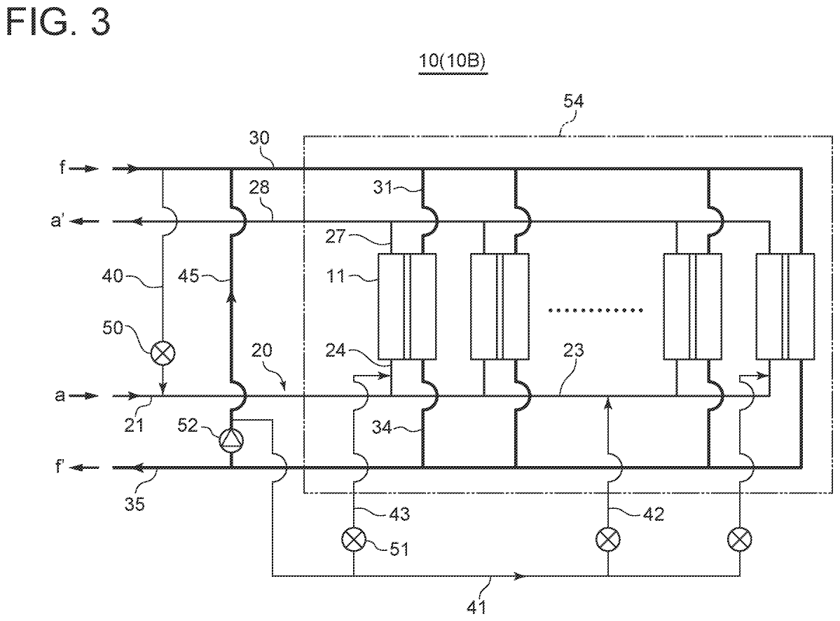

In an embodiment, as shown in FIGS. 3 and 4, a recirculation pipe 45 branching from the fuel gas exhaust pipe 35 and connected to the fuel gas supply pipe 30 is provided. At least part of the exhaust fuel gas f′ discharged to the fuel gas exhaust pipe 35 after being used for power generation of the single fuel cells 14 is supplied to the single fuel cells 14 again by a recirculation blower 52 disposed in the recirculation pipe 45.

In an embodiment, as shown in FIGS. 3 and 4, the upstream end of the heating fuel gas supply main pipe 41 (41a, 41b) is connected to the recirculation pipe 45. At least part of the exhaust fuel gas f′ is added to the oxidant supply fork pipes 23 (23a, 23b) and the oxidant supply branch pipes 24 (24a, 24b) via the heating fuel gas supply pipes 42 (42a, 42b) or 43 (43a, 43b), and is supplied to the air side of the single fuel cells 14. With this configuration, the exhaust fuel gas f′ once discharged from the single fuel cells 14 can be reused as the heating fuel gas f, and by supplying the diluted exhaust fuel gas f′ to the heating fuel gas supply pipe 42 or 43, the concentration of the fuel gas fin multiple heating fuel gas supply pipes disposed in various positions can be adjusted.

In an embodiment, the plurality of cartridges 11 are arranged in a row. In the embodiments shown in FIGS. 1 to 4, they are arranged in one row. Further, the oxidant supply fork pipe 23 and the oxidant supply branch pipe 24 include at least one fork pipe 23 (23a, 23b) arranged along the row direction of the plurality of cartridges 11, and branch pipes 24 (24a, 24b) branching from the fork pipe 23 and connected to each cartridge 11. Further, one or more heating fuel gas supply pipes 42 are connected to the fork pipe 23 that is disposed on a central portion in the cartridge row direction.

According to this embodiment, since the heating fuel gas f is supplied to the fork pipe 23 (23a, 23b) disposed on a central portion in the cartridge row direction, the heating fuel gas f can be supplied to the downstream cartridges 11 in a balanced manner.

In an embodiment, as shown in FIGS. 1 and 2, the plurality of cartridges 11 are arranged in a row. The oxidant supply fork pipe 23 includes at least one fork pipe 23 arranged along the row direction of the plurality of cartridges 11 and branch pipes 24 branching from the fork pipe 23 and connected to each cartridge 11. Further, one or more individual cartridge heating fuel gas supply pipes 43 (43a, 43b) are connected to one or more branch pipes 24 disposed on at least one of both ends in the cartridge row direction.

When the oxidized gas a is supplied from one or few lines to the plurality of cartridges 11 arranged in a row, the temperature of the cartridge 11 at the end in the row direction tends to decrease. However, according to this embodiment, the heating fuel gas f can be supplied directly to the individual cartridge 11 at the end in the row direction without any shortage.

In an embodiment, as shown in FIGS. 2 and 4, a plurality of oxidant supply fork pipes 23 (23a, 23b) branch from the oxidant supply main pipe 21 at the branch point 22, and each oxidant supply fork pipe 23 (23a, 23b) includes a straight pipe portion disposed on a side of the cartridge row. The straight pipe portions are disposed on opposite sides of the cartridge row with the cartridge row interposed therebetween. According to this embodiment, since the straight pipe portions are disposed on opposite sides of the plurality of cartridges 11 arranged in a row, the oxidant supply fork pipes 23 and the oxidant supply branch pipes 24 can be made compact. When a common oxidized gas passage is formed for the single fuel cells 14 accommodated in one cartridge 11, since the heating fuel gas f can be supplied from both sides of each cartridge 11, the flow rate of the heating fuel gas f supplied to the single fuel cells 14 accommodated in each cartridge 11 can be adjusted in the right-left direction with respect to the cartridge row direction.

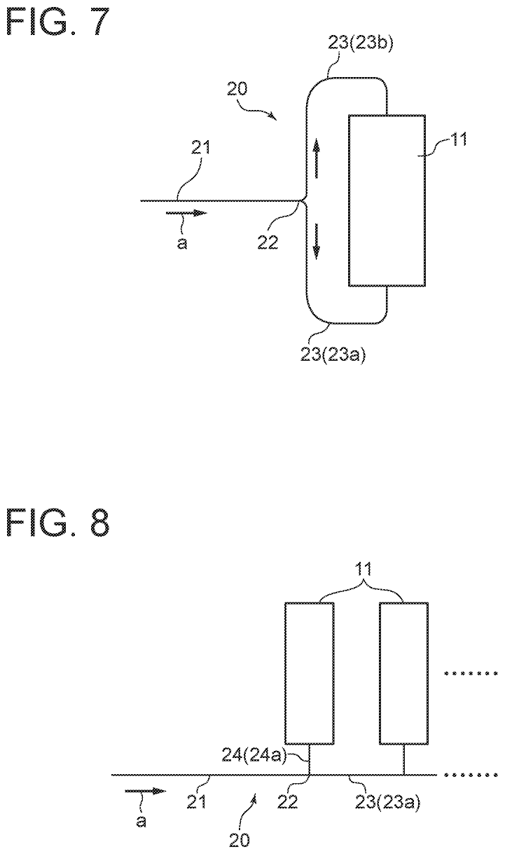

FIGS. 7 to 9 show the oxidized gas supply system 20 according to other embodiments. The fuel cell module shown in FIG. 7 includes one cartridge 11 accommodating a plurality of single fuel cells 14. The oxidized gas supply system 20 includes one oxidant supply main pipe 21 disposed on the upstream side in the flow direction of the oxidized gas a, and two oxidant supply fork pipes 23 (23a, 23b) branching from the oxidant supply main pipe 21 at the branch point 22 positioned at the downstream end of the oxidant supply main pipe 21. The two oxidant supply fork pipes 23 are connected to opposite ends of the cartridge 11, and the oxidized gas a is supplied from both ends of the cartridge 11 to the plurality of single fuel cells 14 accommodated in the cartridge 11.

The fuel cell module shown in FIG. 8 includes a plurality of cartridges 11 arranged in one row. The oxidized gas supply system 20 includes one oxidant supply main pipe 21 disposed on the upstream side in the flow direction of the oxidized gas a, an oxidant supply fork pipe 23 (23a) branching off at the branch point 22, and an oxidant supply branch pipe 24 (24a) branching from the oxidant supply fork pipe 23 downstream of the branch point 22. The oxidant supply branch pipe 24 (24a) is a branch pipe connected to one end of each cartridge 11 for supplying the oxidized gas a to each cartridge 11.

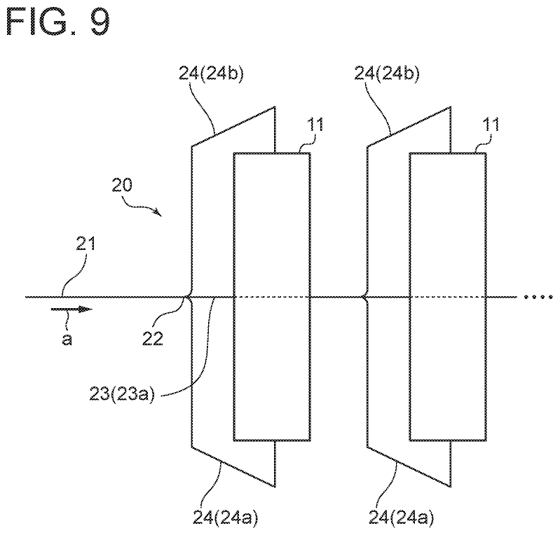

The fuel cell module shown in FIG. 9 includes a plurality of cartridges 11 arranged in one row. The oxidized gas supply system 20 includes one oxidant supply main pipe 21 disposed on the upstream side in the flow direction of the oxidized gas a, an oxidant supply fork pipe 23 (23a) branching off at the branch point 22, and oxidant supply branch pipes 24 (24a, 24b) branching off downstream of the branch point 22. The oxidant supply branch pipes 24 (24a, 24b) are branch pipes branching from the oxidant supply fork pipe 23 (23a) for each cartridge 11. The oxidant supply branch pipes 24 (24a, 24b) are connected to opposite ends of each cartridge 11 for supplying the oxidized gas a to each cartridge 11.

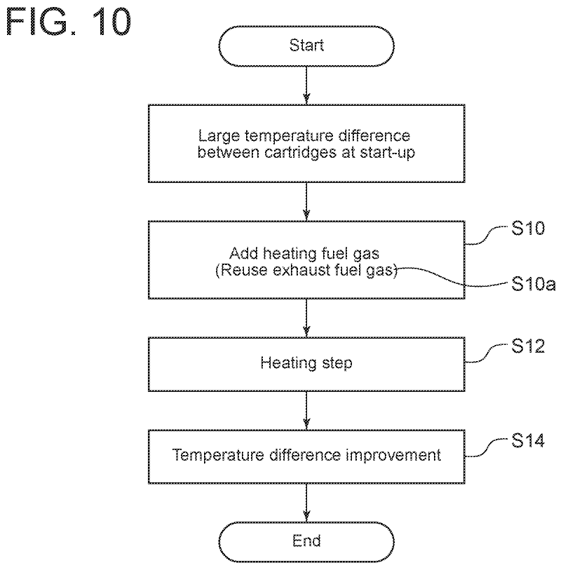

The method of operating the fuel cell module 10 according to an embodiment is performed when the module 10 is started. As shown in FIG. 10, the fuel gas f is added from at least one heating fuel gas supply pipe 42 or 43 to the oxidized gas a flowing through the oxidant supply fork pipe 23 and the oxidant supply branch pipe 24 (step S10). This fuel gas f is combusted at the cathode 17 to heat the single fuel cell 14 (heating step S12). As the method of combusting the fuel gas f, for example, an oxidation catalyst is loaded on the cathode 17, and when the cathode 17 is at a temperature for catalytic combustion (e.g., 400° C. or higher), the fuel gas f is combusted even when the fuel gas f has a concentration below the combustible limit. In the step S10, the heating fuel gas f can be added to the oxidized gas a in various regions of cartridges 11 in the fuel cell module 10, so that the single fuel cells 14 in the module 10 can be adjusted to have a desired temperature distribution. Thus, it is possible to suppress the variation in temperature distribution of the single fuel cells 14 in the module 10 (step S14). Further, since the added fuel gas f is combusted at the cathode 17 of the single fuel cell 14 to heat the single fuel cell 14, the start-up time can be shortened.

In an embodiment, in the step S10, at least part of the fuel gas f discharged from the single fuel cells 14 is added to the oxidized gas a flowing through the oxidant supply fork pipe 23 (reuse step S10a). According to this embodiment, the exhaust fuel gas f′ discharged from the single fuel cells 14 can be reused as the heating fuel gas f, and by supplying the diluted exhaust fuel gas f′ to the heating fuel gas supply pipe 42 or 43, the concentration of the fuel gas fin multiple heating fuel gas supply pipes 42 or 43 disposed in various positions can be adjusted.

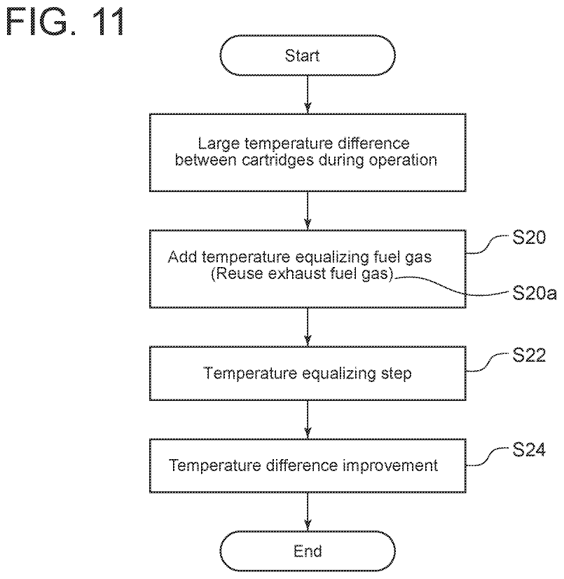

The method of operating the fuel cell module 10 according to an embodiment is performed at rated power generation or at partial load. As shown in FIG. 11, the fuel gas f is added from at least one heating fuel gas supply pipe 42 or 43 to the oxidized gas a flowing through the oxidant supply fork pipe 23 and the oxidant supply branch pipe 24 (step S20).

This fuel gas f is combusted at the cathode 17 to heat the single fuel cell 14 (temperature equalizing step S22). Thus, it is possible to suppress the variation in temperature distribution of the cartridges 11 in the module 10 at rated power generation or at partial load of the module 10 (step S24). For example, at rated power generation, the non-uniformity of the temperature of the cartridges 11 can be mitigated to improve the power generation performance. At partial load, the temperature of the single fuel cell 14 tends to excessively drop below the set temperature. However, by heating the cartridges whose temperature is difficult to maintain by power generation in the step S20 and the temperature equalizing step S22, it is possible to expand the operational range of partial load.

In an embodiment, in the step S20, at least part of the fuel gas f discharged from the single fuel cells 14 is added to the oxidized gas a flowing through the oxidant supply fork pipe 23 (reuse step S20a).

The operation method according to the above-described embodiments can also be applied during operations other than the start-up, rated power generation, or partial load of the module 10, for example, during load fluctuation.

In an embodiment, it is suitable for, for example, SOFC and molten carbonate fuel cell (MCFC) where the single fuel cells 14 have high temperature. These fuel cells require the single fuel cells to be heated to a high temperature to enable operation and take a long time to start power generation, but the time required to start power generation can be shortened by applying the above-described embodiments.

The Fuel cell module 10 may be applied to a combined cycle power generation system used in combination with a gas turbine combined cycle (GTCC), a micro gas turbine (MGT), or a turbocharger.

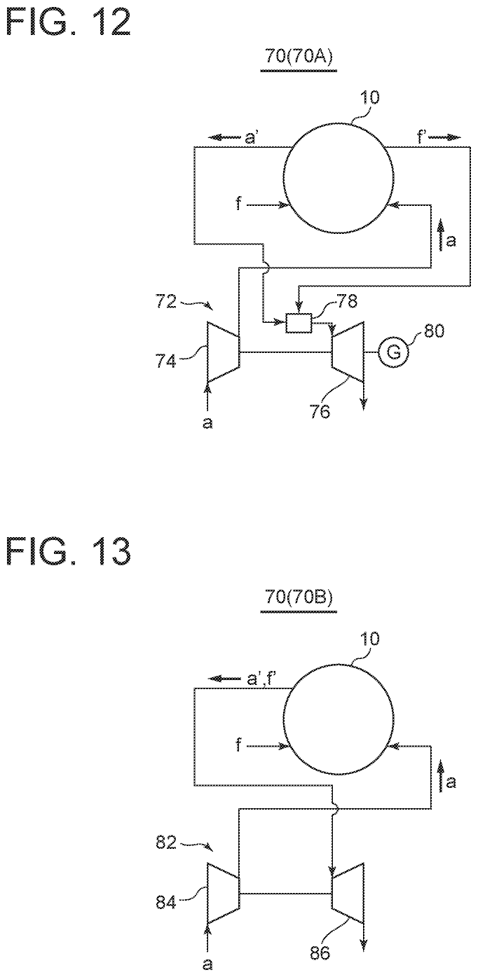

FIG. 12 is a system diagram of a power generation system 70 (70A) according to an embodiment. In FIG. 12, the power generation system 70 (70A) includes the fuel cell module 10 according to some embodiment with the above configuration, and a gas turbine 72 (rotating device). The oxidized gas a is supplied to a compressor 74 constituting the gas turbine 72. After being compressed by the compressor 74, the oxidized gas a is supplied to the fuel cell module 10 through the oxidized gas supply system 20. The exhaust oxidized gas a′ and the exhaust fuel gas f′ used in chemical reaction for power generation in the fuel cell module 10 are supplied to a combustor 78 constituting the gas turbine 72 through the oxidant exhaust pipe 28 and the fuel gas exhaust pipe 35 to produce a hot combustion gas in the combustor 78. The rotational power generated by the adiabatic expansion of this combustion gas in a turbine 76 generates power in a generator 80, and also drives the compressor 74 to generate a compressed gas. This compressed gas is supplied as the oxidized gas a to the oxidized gas supply system 20 of the fuel cell module 10. The fuel cell module 10 generates power using the compressed oxidized gas a and fuel gas f.

With the above configuration, since the fuel cell module 10 according to the above-described embodiments is included, it is possible to suppress the variation in temperature distribution of the plurality of single fuel cells 14 in the module 10. Thus, it is possible to suppress the variation in power generation performance of the plurality of single fuel cells 14 and improve the power generation performance. Further, since the compressed oxidized gas a can be supplied to the fuel cell module 10, the power generation efficiency can be improved. Further, since the combustor 78 is driven by the exhaust oxidized gas a′ and the exhaust fuel gas f′ discharged from the fuel cell module 10 to generate a rotational power, the required power of the power generation system 70 (70A) can be reduced. Furthermore, since both the fuel cell module 10 and the gas turbine 72 can generate power in a combined manner, the power generation amount can be increased.

FIG. 13 is a system diagram of a power generation system 70 (70B) according to an embodiment. In the power generation system 70 (70B), a turbocharger 82 is used as the rotating device. In FIG. 13, the oxidized gas a is supplied to a compressor 84 constituting the turbocharger 82 to compress the oxidized gas, and the compressed oxidized gas a is supplied to the fuel cell module 10. The exhaust oxidized gas a′ and the exhaust fuel gas f′ used in chemical reaction for power generation in the fuel cell module 10 are supplied to a turbine 86 constituting the turbocharger 82 through the oxidant exhaust pipe 28 and the fuel gas exhaust pipe 35 and rotates the turbine 86 to generate a rotational power. This rotational power drives the compressor 84 to generate a compressed gas.

According to this embodiment, it is possible to suppress the variation in temperature distribution of the plurality of single fuel cells 14 in the module 10. Thus, it is possible to suppress the variation in power generation performance of the plurality of single fuel cells 14 and improve the power generation performance. Accordingly, the power generation efficiency of the power generation system 70 (70B) can be improved, and the required power can be reduced.

### INDUSTRIAL APPLICABILITY

According to some embodiments, it is possible to adjust the temperature distribution of the cartridges and the power generation cells accommodated in the fuel cell module to a desired temperature distribution. Thus, it is possible to improve the power generation performance of the module.

### REFERENCE SIGNS LIST

10 Fuel cell module
11 Cartridge
12 Cell stack
13 Substrate tube
14 Single fuel cell
15 Anode
16 Electrolyte
17 Cathode
18 Interconnector
19 Lead film
20 Oxidized gas supply system
21 Oxidant supply main pipe (First line)
22 Branch point
23 (23a, 23b) Oxidant supply fork pipe (Second line)
24 (24a, 24b) Oxidant supply branch pipe (Second line)
25 Oxidant supply header
26 Oxidant exhaust header
27 Oxidant exhaust branch pipe
28 Oxidant exhaust pipe
30 Fuel gas supply pipe
31 Fuel gas supply branch pipe
32 Fuel gas supply header
33 Fuel gas exhaust header
34 Fuel gas exhaust branch pipe
35 Fuel gas exhaust pipe
40 Connection pipe
41 (41a, 41b) Heating fuel gas supply main pipe
42 (42a, 42b) Heating fuel gas supply pipe
43 (43a, 43b) Individual cartridge heating fuel gas supply pipe
44a External pipe portion
44b Internal pipe portion
45 Recirculation pipe
50, 51 Valve
52 Recirculation blower
53 Temperature sensor
54 Pressure vessel
55 Power generation chamber
56, 57, 58, 59, 60 Insulation
70 (70A, 70B) Power generation system
72 Gas turbine
74, 84 Compressor
76, 86 Turbine
82 Turbocharger
78 Combustor
80 Generator
a Oxidized gas
a′ Exhaust oxidized gas
f Fuel gas
f′ Exhaust fuel gas

1. A fuel cell module, comprising:
a plurality of single fuel cells each of which includes an anode, an electrolyte, and a cathode;
a fuel gas supply pipe for supplying a fuel gas to the anode;
an oxidant supply pipe for supplying an oxidized gas to the cathode of the plurality of single fuel cells, the oxidant supply pipe including a first line and a plurality of second lines each of which branches from a branch point at a downstream end of the first line and is connected to one or more single fuel cells; and
at least one heating fuel gas supply pipe connected to the second line downstream of the branch point.

2. The fuel cell module according to claim 1, comprising a fuel gas exhaust pipe for discharging an exhaust fuel gas from the single fuel cells,
wherein an upstream end of the heating fuel gas supply pipe is connected to the fuel gas exhaust pipe, and at least part of the exhaust fuel gas discharged to the fuel gas exhaust pipe is supplied to the single fuel cells through the heating fuel gas supply pipe and the second line.

3. The fuel cell module according to claim 1, comprising one or more cartridges each of which accommodates two or more single fuel cells,
wherein each of the second lines is connected to the one or more cartridges.

4. The fuel cell module according to claim 3,
wherein a plurality of the cartridges are arranged in a row,
wherein the second lines include at least one fork pipe arranged along a row direction of the plurality of cartridges, and branch pipes branching from the at least one fork pipe and respectively connected to the plurality of cartridges, and
wherein the at least one heating fuel gas supply pipe includes a heating fuel gas supply pipe connected to the one fork pipe that is disposed on a central portion in the row direction of the plurality of cartridges.

5. The fuel cell module according to claim 3,
wherein a plurality of the cartridges are arranged in a row,
wherein the second lines include at least one fork pipe arranged along a row direction of the plurality of cartridges, and branch pipes branching from the at least one fork pipe and respectively connected to the plurality of cartridges, and
wherein the at least one heating fuel gas supply pipe includes a heating fuel gas supply pipe connected to the branch pipe connected to the cartridge that is disposed on at least one of both ends in the row direction of the plurality of cartridges.

6. The fuel cell module according to claim 4,
wherein each of the second lines includes a straight pipe portion disposed on a side of a cartridge row, and the respective straight pipe portions of the second lines are disposed on opposite sides of the cartridge row with the cartridge row interposed therebetween.

7. The fuel cell module according to claim 1, comprising a valve disposed in the heating fuel gas supply pipe.

8. The fuel cell module according to claim 7, comprising one or more temperature sensors for detecting a temperature of the single fuel cells.

9. The fuel cell module according to claim 1, comprising a pressure vessel accommodating the plurality of single fuel cells,
wherein the heating fuel gas supply pipe penetrates the pressure vessel and includes an external pipe portion disposed outside the pressure vessel and an internal pipe portion disposed inside the pressure vessel.

10. The fuel cell module according to claim 9, comprising a valve disposed in the heating fuel gas supply pipe,
wherein the valve is disposed outside the pressure vessel.

11. A power generation system, comprising:
the fuel cell module according to claim 1; and
a rotating device configured to generate a rotational power by using an exhaust fuel gas and an exhaust oxidized gas discharged from the fuel cell module,
wherein the fuel cell module is supplied with the oxidized gas compressed by using the rotational power, and the fuel cell module generates power by using the fuel gas and the compressed oxidized gas.

12. The power generation system according to claim 11,
wherein the rotating device comprises a gas turbine or a turbocharger.

13. A method of operating the fuel cell module according to claim 1, the method comprising a heating step of heating the oxidized gas by adding the fuel gas from the at least one heating fuel gas supply pipe to the oxidized gas flowing through the second line.

14. The method of operating the fuel cell module according to claim 13,
wherein the heating step includes adding at least part of the fuel gas discharged from the single fuel cells to the oxidized gas flowing through the second line.

15. The method of operating the fuel cell module according to claim 13,
wherein the heating step is performed when the fuel cell module is started at rated power generation or at partial load.
